(19) United States
(12) Patent Application Publication
(10) Pub. No.: US 2011/0176930 A1
(43) Pub. Date: Jul. 21, 2011

(54) Turbine vane for a gas turbine and casting core for the production of such

(76) Inventors: Fathi Ahmad, Kaarst (DE); Hans-Thomas Bolms, Mulheim an der Ruhr (DE); Christian Lerner, Dorsten (DE)

(21) Appl. No.: 13/002,986

(22) PCT Filed: May 19, 2009
(86) PCT No.: PCT/EP2009/056074

§ 371 Date: Mar. 31, 2011

(30) Foreign Application Priority Data
Jul. 10, 2008 (EP) 08012518.0

(51) Int. Cl. F01D 5/18; B28B 7/28

(52) U.S. Cl. 416/97 R; 249/184

(57) ABSTRACT

A turbine vane or blade including an interior structure is provided. In addition, turbulence elements connected directly upstream of openings disposed at the rear edge of the blade of the turbine vane or blade are also provided. These are disposed in a sequence, each having a flow side against which a coolant flows and which is at least partially arched in a concave manner. Preferably, the turbulence elements are configured in a crescent-shaped manner. This makes it possible to enlarge the openings without resulting in an increased consumption of coolant. A casting core is also provided. The openings required in the casting core for the production of the webs of a turbine vane or blade may now be placed at further distances than before.

### CROSS REFERENCE TO RELATED APPLICATIONS

This application is the U.S. National Stage of International Application No. PCT/EP2009/056074, filed May 19, 2009 and claims the benefit thereof. The International Application claims the benefits of European Patent Office application No. 08012518.0 EP filed Jul. 10, 2008. All of the applications are incorporated by reference herein in their entirety.

### FIELD OF INVENTION

The invention relates to a turbine blade or vane for a gas turbine, having a hollow main blade or vane part around which a hot gas can flow and distributed at the trailing edge of which a plurality of openings for blowing out a coolant which cools the turbine blade or vane are separated from one another by interposed webs, wherein at least one cavity connected fluidically to a plurality of the openings is provided in the interior of the main blade or vane part, in which cavity a plurality of turbulence elements are provided upstream from the webs, which turbulence elements each have an incident-flow side facing toward the flow of coolant that arrives there. Furthermore, the invention relates to a casting core for use in a casting apparatus for producing a cast turbine blade or vane according to the claims, in order to leave behind a cavity, through which a coolant can flow, in the turbine blade or vane after the casting core has been removed from the cast turbine blade or vane.

### BACKGROUND OF INVENTION

A turbine blade or vane of the type mentioned in the introduction and a casting core for producing such a turbine blade or vane are known, for example, from WO 2003/042503 A1. The known turbine blade or vane has a cooled trailing edge, at which a plurality of openings for blowing out the cooling air are separated from one another by interposed webs (also known as “tear drops”). A common cavity is arranged upstream from the openings arranged at the trailing edge, in which cavity there are three rows of pillar-like pedestals (also known as “pin fins”), which are provided for increasing the transfer of heat of the cooling air which brushes past them and for increasing the pressure loss there.

FIG. 7 of WO 2003/042503 A1 shows a perspective illustration of the casting core required for producing such a turbine blade or vane. The space occupied by the casting core remains, after the cast turbine blade or vane has been produced, as a cavity in the turbine blade or vane, wherein openings arranged in the casting core are filled with casting material. In this respect, the casting core represents the negative reflection of the interior of the turbine blade or vane.

The pin fins known from WO 2003/042503 A1 have a cylindrical shape and connect the inner surfaces of the suction-side wall and pressure-side wall, which are located opposite one another, of the main blade or vane part of the turbine blade or vane.

In this context, it is known to set the quantity of cooling air emerging at the trailing edge of the turbine blade or vane by a suitable selection of the maximum pressure loss and/or the smallest cross-sectional area close to the trailing edge through which the cooling air is to flow. However, this procedure can lead to casting cores in which the openings provided at the casting core trailing edge become so large that only still relatively thin separating webs remain between them. During handling of the casting core, however, the casting core can fracture precisely at this point, and therefore it then becomes unusable.

Furthermore, WO 2003/042503 A1 discloses internally arranged C-shaped guide elements for cooling air, which are intended to bring about low-loss deflection and guidance of the cooling air in downstream zones.

Furthermore, EP 1 091 092 A2 discloses an air-cooled turbine blade or vane. In order to achieve particularly efficient cooling of a hollow-walled suction or pressure side of the main blade or vane part, pins are arranged in grid form in the cavity of the double wall. In principle, the pins are diamond-shaped, with the corners thereof being rounded off and the edges thereof being curved concavely inward. Between the pins, a network of passages therefore arises for cooling air, these passages each having a narrowed inlet opening and a narrowed outlet opening, between which there is a diffuser and nozzle portion. The portions are intended to be used to decelerate and accelerate the cooling air in order to achieve the efficient cooling.

### SUMMARY OF INVENTION

It is therefore an object of the invention to provide a turbine blade or vane of the type mentioned in the introduction for a gas turbine, which can be cooled efficiently and sufficiently using the smallest quantity of coolant possible and/or in which a casting core in a casting apparatus which can be handled particularly robustly can be used for production.

The object relating to the turbine blade or vane is achieved by a turbine blade or vane according to the features of the claims. The object relating to the casting core is achieved by a casting core according to the features of the claims

The invention is based on the recognition that it is possible to achieve a more stable casting core if the first openings arranged in the casting core trailing edge are further reduced in size in longitudinal section, such that the separating webs arranged therebetween in the casting core are widened. However, in a turbine blade or vane produced with such a casting core, this widening of the separating webs arranged in the casting core enlarges the openings arranged at the trailing edge, through which the coolant escapes from the turbine blade or vane. Since these openings have also served to date for setting the coolant consumption, enlarged openings thus lead to an increased consumption of coolant. In principle, this increase is undesirable and reduces the efficiency of the gas turbine. In order to counter this effect, therefore, the invention proposes to increase the pressure loss in the region upstream from the trailing edge openings in the turbine blade or vane (more precisely: in a cavity arranged fluidically upstream from the openings) and therefore to provide an increased flow resistance there, in order to compensate, if not even overcompensate, for the above-mentioned effect of increased passage of coolant. In order to achieve a further increased pressure loss—compared with the cylindrical pin fins known from the prior art—in the flow of coolant upstream from the openings at the trailing edge of the turbine blade or vane, the invention proposes to provide a plurality of turbulence elements upstream from the webs, which turbulence elements each have an incident-flow side which faces toward the flow of coolant arriving there and is at least partially concavely curved. This measure makes it possible to accept an enlargement of the openings without an increased consumption of coolant being established as a result.

A further advantage of the concavely curved incident-flow side of the turbulence elements is a further increase in the transfer of heat between the inner surfaces of the side walls of the main blade or vane part and the flow of coolant which flows along the latter as a result of further increased turbulence in the coolant.

In this case, the geometrical dimensioning of the turbulence elements according to the invention, such as curvature of the incident-flow side, magnitude of the longitudinal extent and/or distance between the turbulence elements arranged in a row, is selected suitably so as to set the required internal pressure loss and/or the desired transfer of heat.

In this case, it is possible to derive correlations between the different geometrical dimensions with respect to the quantity of cooling air flowing through them and the pressure differences.

The pressure loss and transfer of heat can also be set by the suitable selection of the number of turbulence elements according to the invention within a row transversely to the main direction of flow of the coolant.

The main blade or vane part comprises a suction-side wall and a pressure-side wall, the respective inner surfaces of which laterally delimit the cavity and the channels which extend from the cavity toward the openings between the webs. In this case, the turbulence elements each extend from one of the two inner surfaces to the other inner surface and connect them. The flow of coolant between the inner surface of the pressure-side wall and the inner surface of the suction-side wall is therefore partially blocked. Irrespective of the extent of the turbulence elements from one inner surface to the other inner surface, it is also possible for the two inner surfaces of the side walls to be inclined in relation to one another in such a manner that—as seen in cross section of the main blade or vane part—they converge to the trailing edge of the turbine blade or vane. In particular, it is thereby possible to provide the minimum cross section of the turbine blade or vane through which the coolant can flow in a region in which the turbulence elements are arranged. This represents a further difference with respect to a turbine blade or vane known from the prior art, in which the smallest cross section through which the coolant can flow is generally present between the webs which separate the openings or channels arranged in the trailing edge of the turbine blade or vane from one another.

This can lead to a minor (but essential) advancement of the throttle point into the region of the turbulence elements, i.e. out of the region of the webs.

As seen in longitudinal section, the turbulence elements have a C-shaped design. The arcuate form of the turbulence elements can consequently be like a circular segment or else like an ellipse segment, i.e. crescent-shaped. If flow is incident on the ends, such a shape brings about a relatively large pressure loss.

Furthermore, it is provided that the arc ends of the turbulence elements are oriented in such a manner that they at least slightly face toward the flow of coolant that arrives there during operation. The coolant which impinges on the concavely curved incident-flow side can therefore be guided by the two arc ends to the center located between them and be captured, as a result of which a particularly large dynamic pressure is established upstream thereof in the flow of coolant, which can lead to a particularly high pressure loss. Diversion of the cooling air should not occur with the turbulence elements according to the invention.

Advantageous refinements are given in the dependent claims.

According to a first advantageous development, the turbulence elements can be arranged directly upstream from the webs in at least one row transversely to the main direction of flow of the coolant. In this case, it is preferable for each of the turbulence elements in the row to have an at least partially concavely curved incident-flow side. It is thereby possible to set a uniform pressure loss for the coolant and a uniform transfer of heat over the entire longitudinal extent of the turbine blade or vane—in other words: over the entire height of the main blade or vane part. However, it is also conceivable to provide different geometries of turbulence elements according to the invention or else different distances in a row, in order to meet local demands relating to the cooling.

In the case of a turbine blade or vane according to the invention, it is expedient that—as seen in the longitudinal direction of the main blade or vane part—the distance between two adjacent turbulence elements can be smaller than the respective extent thereof in the longitudinal direction by a factor of 2.

According to a further advantageous refinement, it is possible for a further means for stimulating the turbulence of the coolant flowing through the cavity to the openings to be provided upstream and/or downstream from the turbulence elements. In this case, the further means may comprise a multiplicity of pillars or pedestals arranged in a grid, i.e. the cylindrical pin fins known from the prior art. As an alternative or in addition, it is also conceivable for the further means to be formed from at least one further row of turbulence elements according to the invention. Consequently, it is possible not only for a single row of turbulence elements according to the invention to be present, but also a plurality of rows of turbulence elements according to the invention, which are each preferably oriented perpendicularly to the flow of coolant. This further increases the pressure loss.

The cavities and outlet openings present in a cast turbine blade or vane can be produced by a casting core used in a casting apparatus, which casting core is removed from the turbine blade or vane in a known manner after the latter has been cast. In order to produce a cast turbine blade or vane according to the claims, the invention proposes a casting core for use in a casting apparatus, which comprises a casting core trailing edge, at which a plurality of first openings are arranged for forming the webs in the trailing edge of the turbine blade or vane. In addition, the casting core comprises a plurality of second openings which are arranged in a second region adjacent to a first region in which the first openings are arranged. The second openings in the casting core serve to produce the turbulence elements according to the invention.

According to the invention, it is provided that at least one of the second openings is at least partially concavely shaped. In order to form correspondingly shaped turbulence elements in the turbine blade or vane, the concave part of the second openings faces away from the casting core trailing edge. Such a casting core can be used to produce turbine blades or vanes according to the invention which, upstream from the webs, i.e. in the interior of the turbine blade or vane, produce a relatively high pressure loss for the coolant, as a result of which the webs present between the openings provided in the turbine blade or vane trailing edge can be made narrower. Here, the narrower webs are obtained using a casting core of which the first openings at the casting core trailing edge are likewise narrower. Separating webs present between the first openings in the casting core—which separating webs define the openings in the trailing edge in the cast turbine blade or vane—have—with respect to the conventional casting core—a relatively wide form, and this increases the overall stability of the casting core. In the vicinity of the casting core trailing edge, a casting core configured according to the invention is therefore less likely to fracture than a conventional casting core and can accordingly be handled with greater ease and more robustly.

### BRIEF DESCRIPTION OF THE DRAWINGS

Preferred exemplary embodiments of the invention are shown in the drawings and are explained in more detail in the description of the figures which follows, where identical reference signs refer to identical or similar or functionally identical components. Schematically,

FIG. 1 shows a perspective illustration of a turbine rotor blade known from the prior art,

FIG. 2 shows a longitudinal section through the region of the trailing edge of the turbine rotor blade known from the prior art,

FIG. 3 shows a section analogous to FIG. 2 through a turbine blade or vane according to the invention with concavely curved incident-flow sides according to a first refinement,

FIG. 4 shows an alternative refinement of the turbulence elements arranged in rows of a turbine blade or vane according to the invention,

FIG. 5 shows a perspective illustration of a casting core according to the invention for producing a turbine blade or vane according to the invention, and

FIG. 6 shows a cross section through the trailing edge of a turbine blade or vane according to the invention.

### DETAILED DESCRIPTION OF INVENTION

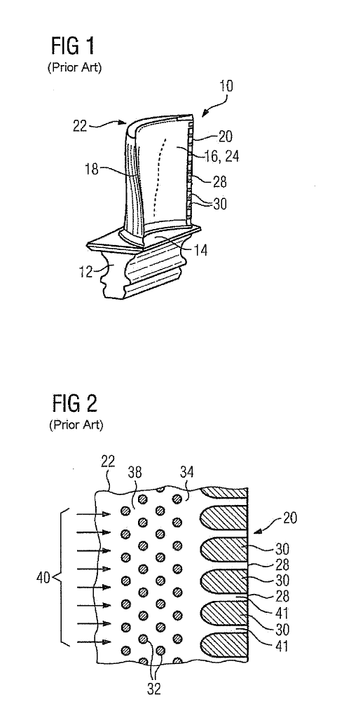

FIG. 1 is a perspective illustration of a gas turbine blade or vane 10 relating to the invention. According to FIG. 1, the gas turbine blade or vane 10 is in the form of a rotor blade. The invention can also be used in a guide vane (not shown) of a gas turbine. The turbine blade or vane 10 comprises a blade or vane root 12, with a fir tree-like cross section, and also a platform 14 arranged thereon. An aerodynamically curved main blade or vane part 16 adjoins the platform 14 and comprises a leading edge 18 and also a trailing edge 20. Cooling openings arranged as a so-called “shower head” are provided on the leading edge 18, from which cooling openings an internally flowing coolant, preferably cooling air, can emerge. The main blade or vane part 16 comprises a—with respect to FIG. 1—rear-side suction-side wall 22 and also a front-side pressure-side wall 24. A multiplicity of trailing edge openings 28 separated from one another by interposed webs 30 are provided along the trailing edge 20. In this case, the trailing edge 20 is in the faun of a so-called cut-back trailing edge, and therefore the openings 28 lie more on the pressure side than in the center of the trailing edge 20.

FIG. 2 shows the interior of the turbine blade or vane 10 known from the prior art in a longitudinal section along a plane, spanned by a center line, which extends from the leading edge 18 to the trailing edge 20 of the main blade or vane part 16, and by the longitudinal direction of the blade or vane, which extends from the blade or vane root 12 toward the blade or vane tip.

In FIG. 2, the trailing edge openings 28, between which the webs 30 are arranged, are provided arranged further to the right. The webs 30 extend substantially parallel to a flow of hot gas which, during operation, flows around the main blade or vane part 16 from the leading edge 18 to the trailing edge 20. Shown on the left in FIG. 2, a multiplicity of pillars or pedestals 32 arranged in a grid are provided. In this case, both the pillars 32 and the webs 30 extend from an inner surface 34 of the suction-side wall 22 to an inner surface (not shown) of the pressure-side wall 24. Consequently, the pillars 32 are arranged in a cavity 38 of the turbine blade or vane 10 which is laterally delimited by the suction-side wall 22 and the pressure-side wall 24.

If the turbine blade or vane 10 is used in a gas turbine, a coolant, preferably cooling air 40, flows through the cavity 38 during operation. The part (not shown in FIG. 2) of the turbine blade or vane in the interior is generally designed such that the field of pedestals 32 is subjected to a substantially uniform incident flow of cooling air 40. The uniform incident flow onto the pedestals 32 arranged in the grid is shown by the arrows marked with 40. The cooling air 40 impinges on individual pedestals 32 and, in the process, is deflected by these, with the main direction of flow 40 of said cooling air remaining substantially unchanged. Turbulences are thereby produced in the cooling air 40. The heat introduced by the hot gas into the blade or vane walls 22, 24 is thereby conducted further into the pedestals 32, where the cooling air 40 impinging on the pedestals 32 absorbs the heat and carries it away. Once the cooling air 40 has flowed through the field of pedestals, it enters channels 41 which connect the cavity 38 to the openings 28. Once it has flowed through the channels 41, the cooling air 40 passes out of the turbine blade or vane 10 through the openings 28 and blends with the hot gas flowing around the main blade or vane part 16.

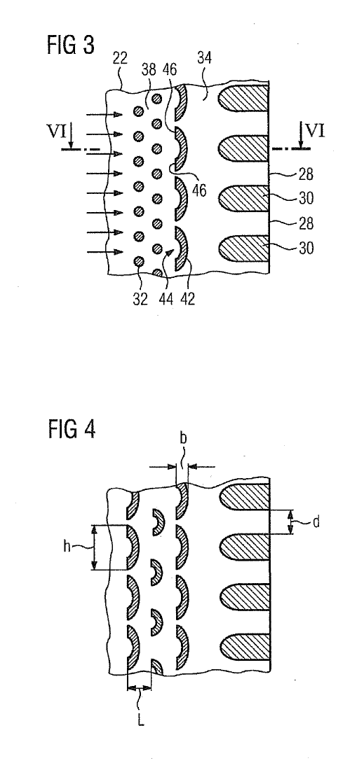

The turbulences in the coolant 40 which are produced as the latter flows through the field of pedestals increase the transfer of heat from the side walls 22, 24 of the main blade or vane part 16 into the cooling air, and therefore it is possible to achieve a relatively efficient dissipation of heat. In order to achieve a further increased transfer of heat from the side walls 22, 24 into the cooling air 40, without further increasing the quantity of cooling air 40 required, the invention shown in FIG. 3 proposes novel turbulence elements 42. The turbulence elements 42 shown in FIG. 3 have an at least partially concavely curved incident-flow side 44 which faces toward the incident flow of cooling air 40. The turbulence elements 42 according to the invention therefore have a C-shaped longitudinal section, i.e. are in the form of a crescent, with the arc ends 46 of the turbulence elements 42 being oriented in such a manner that they at least slightly face toward the flow of coolant that arrives there during operation. The turbulence elements 42 are arranged in a row transversely to the main direction of flow of the coolant, wherein each of the turbulence elements 42 in a row has an at least partially concavely curved incident-flow side 44 or is crescent-shaped. In contrast to the arrangement known from the prior art shown in FIG. 2, two rows of pin fins have been replaced by one row of turbulence elements 42 according to the invention.

As shown in FIG. 3 and FIG. 4, in this case the crescent shape of the turbulence elements 42 can be oriented in the cavity 38 such that the ends of a turbulence element 42 lie at different heights of the main blade or vane part 16. When installed in a turbine, these turbulence elements then lie at different radii—in relation to a machine axis of the gas turbine about which the rotor rotates. As an alternative, however, it is also conceivable for the turbulence elements 42 to be crescent-shaped both in longitudinal section and additionally in cross section. This results in an overall cup- or plate-shaped contour of the turbulence element 42 with an at least partially spherical incident-flow side 44, which produces a particularly large pressure loss.

By positioning turbulence elements 42 according to the invention upstream from the webs 30, in the interior of the turbine blade or vane 10, it is possible to enlarge a width d (FIG. 4) of the opening 28, without an increased consumption of cooling air arising as a result. Compared with the pedestals 32 arranged in rows, the turbulence elements 42 have a further increased flow resistance, and therefore an increased pressure loss which prevents an increase in coolant consumption is established at this point.

According to FIG. 4, it goes without saying that it is also conceivable to use different geometrical refinements of turbulence elements 42 according to the invention in different rows. By way of example, it is thus possible to adapt a length h in the longitudinal direction, a width b and thus the curvature of the concave incident-flow side 44 of the turbulence elements 42 and the distance L between two adjacent rows to local requirements.

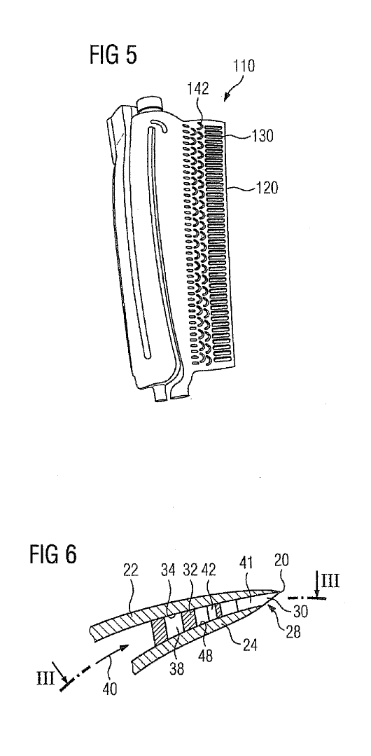

FIG. 6 shows the section VI from FIG. 3 through a turbine blade or vane according to the invention with the novel turbulence elements 42. The suction-side wall 22 and the pressure-side wall 24 extend toward the trailing edge 20. The openings 28 for their part are separated from one another by interposed webs 30. An inner surface 34 of the suction-side wall 22 lies opposite to an inner surface 48 of the pressure-side wall 24 in the form of a wedge such that, as seen in the main direction of flow of the coolant 40, these inner surfaces converge toward the trailing edge 20, i.e. taper toward one another. Two rows of pedestals 32 are provided firstly in succession in the main direction of flow between the inner surfaces 34, 48, and these are followed fluidically downstream by a row of turbulence elements 42 designed according to the invention. These turbulence elements are followed by the webs 30 with the interposed channels 41.

FIG. 5 shows a perspective illustration of a casting core 110 according to the invention with first openings 130 arranged in a first region in the vicinity of the casting core trailing edge 120. A multiplicity of second openings 142 arranged in two rows are provided adjacent thereto in a second region. The second openings 142 have at least one concavely shaped partial contour.

By using the casting core 110 in a casting apparatus, it is possible to use said casting core to produce a turbine blade or vane according to the invention, wherein the space occupied by the casting core 110 remains, after the cast turbine blade or vane has been produced, as a cavity in the turbine blade or vane. The openings 130, 142 present in the casting core 110 are filled with cast material as the turbine blade or vane 10 is being cast, and therefore subsequently remain as structural elements, namely as webs 30 and turbulence elements 42, in the turbine blade or vane.

Overall, a casting core 110 according to the invention has a contour complementary to the interior according to the invention of the turbine blade or vane.

The invention can be used both in a rotor blade and in a guide vane.

Overall, the invention proposes a turbine blade or vane with a partially novel internal structure. The novel elements are arranged upstream from the webs 30 arranged at the trailing edge 20 of the main blade or vane part 16 of the turbine blade or vane. The structure contains turbulence elements 42, which are arranged in a row and have an incident-flow side 44 which can be subjected to incident flow of a coolant 40 and, according to the invention, is at least partially concavely curved. The turbulence elements 42 are preferably in the form of a crescent. This aerodynamically particularly awkward shape of the turbulence elements 42 brings about an increased pressure loss, which makes it harder for coolant to flow through. This makes it possible to enlarge the width d of the openings 28 (cf. FIG. 4) compared to a turbine blade or vane 10 known from the prior art, without an increased consumption of coolant being established as a result. The invention also provides a significantly more stable casting core 110, since the first openings 130 required in the casting core 110 for producing the webs 30 of a turbine blade or vane can now be spaced apart to a greater extent than has previously been possible. This results in greater stability of the casting core 110 in the region of the casting core trailing edge 120, as a result of which said casting core is less likely to fracture at this point and can therefore be handled more robustly.

1.-10. (canceled)

11. A turbine blade or vane for a gas turbine, comprising:
a hollow main blade or vane part around which a hot gas may flow;
a plurality of openings;
a plurality of interposed webs;
a cavity; and
a plurality of turbulence elements,
wherein the plurality of openings are distributed at a trailing edge of the blade or vane, and used for blowing out a coolant, which cools the turbine blade or vane, and are separated from one another by the plurality of interposed webs,
wherein the cavity is connected fluidically to the plurality of the openings and is provided in an interior of the main blade or vane part;
wherein in the cavity the plurality of turbulence elements are provided upstream from the plurality of interposed webs,
wherein each turbulence element extends from a first inner surface of a suction-side wall of the main blade or vane part to a second inner surface of a pressure-side wall of the main blade or vane part and each has an incident-flow side facing toward a flow of coolant that arrives there,
wherein at least one of the plurality of turbulence elements as seen in a longitudinal section and/or a cross section of the main blade or vane part includes a C-shaped design with an at least partially concavely curved incident-flow side, and
wherein the two arc ends of the turbulence element which lie at opposite ends from one another face toward the flow of coolant that arrives there during operation to increase a pressure loss.

12. The turbine blade or vane as claimed in claim 11, wherein the plurality of turbulence elements are arranged upstream from the plurality of webs in a row transversely to a main direction of flow of the coolant and/or each of the plurality of turbulence elements in the row includes an at least partially concavely curved incident-flow side.

13. The turbine blade or vane as claimed in claim 11, wherein a distance between two adjacent turbulence elements in a longitudinal direction of the main blade or vane part is smaller than a longitudinal length of each turbulence element by a factor of 2.

14. The turbine blade or vane as claimed in claim 11, wherein the first and second inner surfaces are inclined in relation to one another so that, as seen in cross section of the main blade or vane part, the first and second inner surfaces converge to the trailing edge of the turbine blade or vane.

15. The turbine blade or vane as claimed in claim 11, wherein a further means for stimulating the turbulence of the coolant flowing through the cavity to the plurality of openings is provided in the cavity upstream and/or downstream from the plurality of turbulence elements.

16. The turbine blade or vane as claimed in claim 15, wherein the further means comprises a plurality of pillars/pedestals arranged in a grid.

17. The turbine blade or vane as claimed in claim 16, wherein the plurality of pillars or pedestals include a cylindrical design.

18. The turbine blade or vane as claimed in claim 15, wherein the further means is formed from a row of elements, a first contour of which corresponds to a second contour of one of the plurality of turbulence elements.

19. A casting core for use in a casting apparatus for producing a cast turbine blade or vane, comprising:
a first region in a vicinity of a casting core trailing edge, at which a plurality of first openings are arranged for forming webs in the trailing edge of the turbine blade or vane; and
a plurality of second openings which are arranged in a second region adjacent to the first region of the first openings by means of which a plurality of turbulence elements remain in the cast turbine blade or vane,
wherein the casting core is used in order to leave behind a cavity, through which a coolant may flow in the turbine blade or vane after the casting core has been removed from the cast turbine blade or vane,
wherein at least one of the second openings is at least partially concavely shaped in order to form correspondingly shaped, C-shaped turbulence elements in the turbine blade or vane, and
wherein the concave part of a first or second opening and the two arc ends of the C-shape of the second opening face away from the casting core trailing edge.

20. The casting core as claimed in claim 19, wherein the cast turbine blade or vane comprises:
a hollow main blade or vane part around which a hot gas may flow;
a plurality of openings;
a plurality of interposed webs;
a cavity; and
a plurality of turbulence elements,
wherein the plurality of openings are distributed at a trailing edge of the blade or vane, and used for blowing out a coolant, which cools the turbine blade or vane, and are separated from one another by the plurality of interposed webs,
wherein the cavity is connected fluidically to the plurality of the openings and is provided in an interior of the main blade or vane part;
wherein in the cavity the plurality of turbulence elements are provided upstream from the plurality of interposed webs,
wherein each turbulence element extends from a first inner surface of a suction-side wall of the main blade or vane part to a second inner surface of a pressure-side wall of the main blade or vane part and each has an incident-flow side facing toward a flow of coolant that arrives there,
wherein at least one of the plurality of turbulence elements as seen in a longitudinal section and/or a cross section of the main blade or vane part includes a C-shaped design with an at least partially concavely curved incident-flow side, and
wherein the two arc ends of the turbulence element which lie at opposite ends from one another face toward the flow of coolant that arrives there during operation to increase a pressure loss.

21. The casting core as claimed in claim 20, wherein the plurality of turbulence elements are arranged upstream from the plurality of webs in a row transversely to a main direction of flow of the coolant and/or each of the plurality of turbulence elements in the row includes an at least partially concavely curved incident-flow side.

22. The casting core as claimed in claim 20, wherein a distance between two adjacent turbulence elements in a longitudinal direction of the main blade or vane part is smaller than a longitudinal length of each turbulence element by a factor of 2.

23. The casting core as claimed in claim 20, wherein the first and second inner surfaces are inclined in relation to one another so that, as seen in cross section of the main blade or vane part, the first and second inner surfaces converge to the trailing edge of the turbine blade or vane.

24. The casting core as claimed in claim 20, wherein a further means for stimulating the turbulence of the coolant flowing through the cavity to the plurality of openings is provided in the cavity upstream and/or downstream from the plurality of turbulence elements.

25. The casting core as claimed in claim 24, wherein the further means comprises a plurality of pillars/pedestals arranged in a grid.

26. The casting core as claimed in claim 25, wherein the plurality of pillars or pedestals include a cylindrical design.

27. The casting core as claimed in claim 24, wherein the further means is formed from a row of elements, a first contour of which corresponds to a second contour of one of the plurality of turbulence elements.
